(19) United States
(12) Patent Application Publication
(10) Pub. No.: US 2006/0146512 A1
(43) Pub. Date: Jul. 6, 2006

(54) Lamp supporter, backlight assembly having the same, and liquid crystal display device having the same

(76) Inventor: Seong-Sik Choi, Seoul (KR)

Correspondence Address: CANTOR COLBURN, LLP, 55 GRIFFIN ROAD SOUTH, BLOOMFIELD, CT, 06002, US

(21) Appl. No.: 11/320,324

(22) Filed: Dec. 27, 2005

(30) Foreign Application Priority Data
Dec. 27, 2004 (KR) 2004-113074

(51) Int. Cl. G01D 11/28

(52) U.S. Cl. 362/29; 362/225; 362/223

(57) ABSTRACT

In a lamp supporter, a backlight assembly having the same and an LCD device having the same, the lamp supporter includes a base part and a lamp holding part. The lamp holding part is connected to the base part. The lamp holding part includes at least two lamp holders arranged in a first direction. Each of the two lamp holders is configured to receive a portion of a lamp. Therefore, impact resistance of the backlight assembly is improved.

The present application claims priority from Korean Patent Application No. 2004-113074, filed on Dec. 27, 2004, and the benefits accruing therefrom under 35 U.S.C. §119, the contents of which are herein incorporated by reference in its entirety.

### BACKGROUND OF THE INVENTION

1. Field of the Invention

The present invention relates to a lamp supporter, a backlight assembly having the lamp supporter, and a liquid crystal display (LCD) device having the backlight assembly. More particularly, the present invention relates to a lamp supporter capable of improving impact resistance, a backlight assembly having the lamp supporter, and an LCD device having the backlight assembly.

2. Description of the Related Art

An LCD device displays images using a liquid crystal that has optical characteristics such as anisotropy of refractivity and electrical characteristics such as anisotropy of dielectric constant. The LCD device has various characteristics such as generally a thin thickness cross section, lower driving voltage, lower power consumption, etc., compared with other display devices such as a cathode ray tube (CRT) device and a plasma display panel (PDP) device, etc. Therefore, the LCD device may be used in notebook computers, monitors, and television sets, etc.

The LCD device may be a non-emissive type display device that includes a backlight assembly for supplying a LCD panel of the LCD device with light.

The backlight assembly includes a light source to generate the light. The backlight assembly may include a cold cathode fluorescent lamp (CCFL), a light emitting diode (LED), etc., as the light source. The backlight assembly may be classified into, for example, an edge illumination type or a direct illumination type, based on a location of the light source. In the edge illumination type, the backlight assembly generally includes a light guiding plate and one or two light sources adjacent to a side surface of the light guiding plate so that the light generated from the light sources is guided toward an LCD panel of the LCD device. In the direct illumination type, the backlight assembly generally includes a plurality of light sources disposed under the LCD panel, and an optical plate disposed between the LCD panel and the light sources for changing optical characteristics of the light generated from the light sources, where the light that has passed through the optical plate is irradiated into the LCD panel. Generally, a small screen LCD device may include the edge illumination type backlight assembly of a thin thickness cross section, while a large screen LCD device may include the direct illumination type backlight assembly of a high luminance.

When a large-screen LCD device has the direct illumination type backlight assembly, a length of the lamp and a size of the diffusion plate may be increased to where the backlight assembly includes a lamp supporter configured to support the lamp and the diffusion plate.

When an exterior portion of the LCD device receives an impact, the lamps may become damaged or separated from the lamp supporter. In addition, a portion of the lamps may have a higher stress level due to the impact making that portion of the lamps more susceptible to damage. Therefore, it is desirable to provide a lamp supporter that supports the diffusion plate and the lamps while substantially minimizing or eliminating damage to the lamps from an impact applied to an exterior portion of the LCD device.

### SUMMARY OF THE INVENTION

The present invention provides a lamp supporter capable of improved impact resistance.

The present invention provides a backlight assembly having the above-mentioned lamp supporter.

The present invention also provides an LCD device having the above-mentioned backlight assembly.

A lamp supporter in accordance with an aspect of the present invention includes a base part and a lamp supporting part. The lamp supporting part is connected to the base part. The lamp supporting part includes at least two lamp holders arranged in a first direction. The lamp holders are configured to receive a portion of a lamp.

A backlight assembly in accordance with an aspect of the present invention includes a receiving container, a lamp supporter, and a plurality of lamps. The receiving container includes a bottom plate and sidewalls that protrude from sides of the bottom plate to form a receiving space. The lamp supporter is combined with the bottom plate. The lamp supporter includes a lamp supporting part having at least two lamp holders that are arranged in a first direction. The lamps are disposed in the receiving container in the first direction, wherein portions of the lamps are supported by the lamp holders.

A backlight assembly in accordance with another aspect of the present invention includes a receiving container, a lamp supporter, and a plurality of lamps. The receiving container includes a bottom plate and sidewalls that protrude from sides of the bottom plate to form a receiving space. The lamp supporter is combined with the bottom plate. The lamp supporter includes a lamp supporting part having a lamp holder that includes an opened portion facing toward the bottom plate. The lamps are disposed in the receiving container, wherein a portion of the lamp is supported by the lamp holder.

An LCD device in accordance with an aspect of the present invention includes a backlight assembly and an LCD panel. The backlight assembly includes a receiving container, a lamp supporter, and a plurality of lamps. The receiving container includes a bottom plate and sidewalls that protrude from sides of the bottom plate to form a receiving space. The lamp supporter is combined with the bottom plate. The lamp supporter includes a lamp supporting part having at least two lamp holders that are arranged in a first direction. The lamps are disposed in the receiving container, wherein portions of the lamps are supported by the lamp holders. The LCD panel displays images using a light generated from the backlight assembly.

An LCD device in accordance with another aspect of the present invention includes a backlight assembly and an LCD panel. The backlight assembly includes a receiving container, a lamp supporter, and a plurality of lamps. The receiving container includes a bottom plate and sidewalls that protrude from sides of the bottom plate to form a receiving space. The lamp supporter is combined with the bottom plate. The lamp supporter includes a lamp supporting part having a lamp holder that includes an opened portion facing toward the bottom plate. The lamps are disposed in the receiving container, wherein a portion of the lamp is supported by the lamp holder. The LCD panel displays images using light generated from the backlight assembly.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing an exemplary embodiment of a backlight assembly in accordance with the present invention;

FIG. 2 is a perspective view showing an exemplary embodiment of a lamp supporter shown in FIG. 1;

FIG. 3 is a cross-sectional view showing the backlight assembly shown in FIG. 1;

FIG. 4 is a plan view showing an exemplary embodiment of a receiving container, lamp supporters, and lamps shown in FIG. 1;

FIG. 5 is a cross-sectional view showing another exemplary embodiment of a backlight assembly in accordance with the present invention;

FIG. 6 is a perspective view showing an exemplary embodiment of a lamp supporter shown in FIG. 5;

FIG. 7 is a perspective view showing another exemplary embodiment of a lamp supporter in accordance with the present invention; and

FIG. 8 is an exploded perspective view showing an exemplary embodiment of an LCD device in accordance with the present invention.

### DETAILED DESCRIPTION OF THE INVENTION

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer or section from another region, layer, or section. Thus, a first element, component, region, layer, or section discussed below could be termed a second element, component, region, layer, or section without departing from the teachings of the present invention.

Spatially relative terms, such as “below”, “above”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Hereinafter, the present invention will be described in detail with reference to the accompanying drawings.

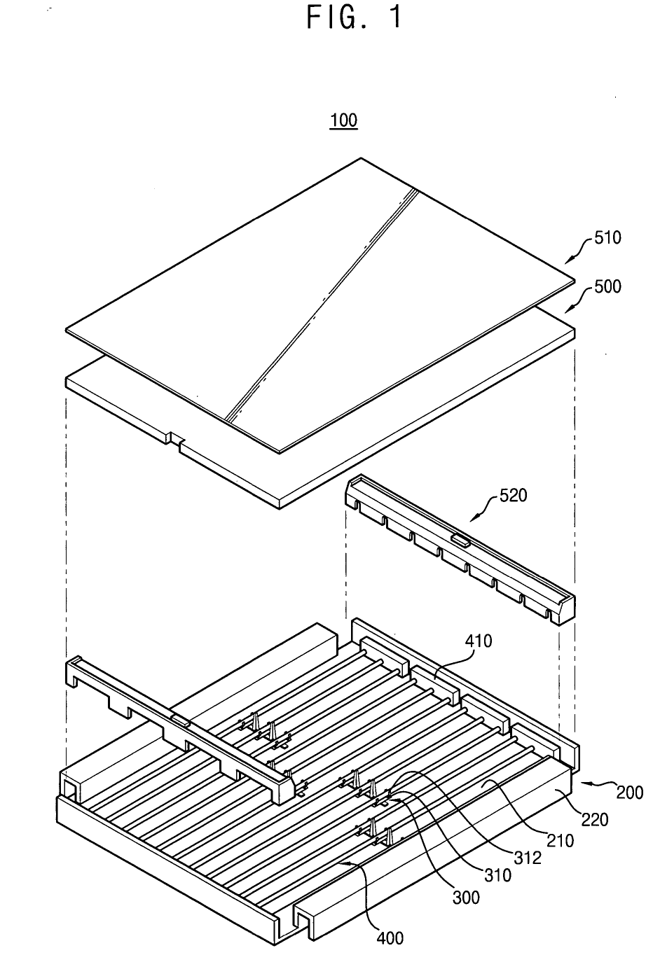

FIG. 1 is an exploded perspective view showing an exemplary embodiment a backlight assembly in accordance with the present invention.

Referring to FIG. 1, the backlight assembly 100 includes a receiving container 200, a lamp supporter 300, and a plurality of lamps 400. The receiving container 200 includes a bottom plate 210 and a plurality of sidewalls 220 that protrude from sides of the bottom plate 210 defining a receiving space. A portion of the sidewalls 220 may be bent to form a U shape so that the sidewalls 220 may be securely combined with other elements such as a chassis, a mold frame, etc. The receiving container 200 may be constructed from a strong material such as a metal or plastic that may not be substantially deformed.

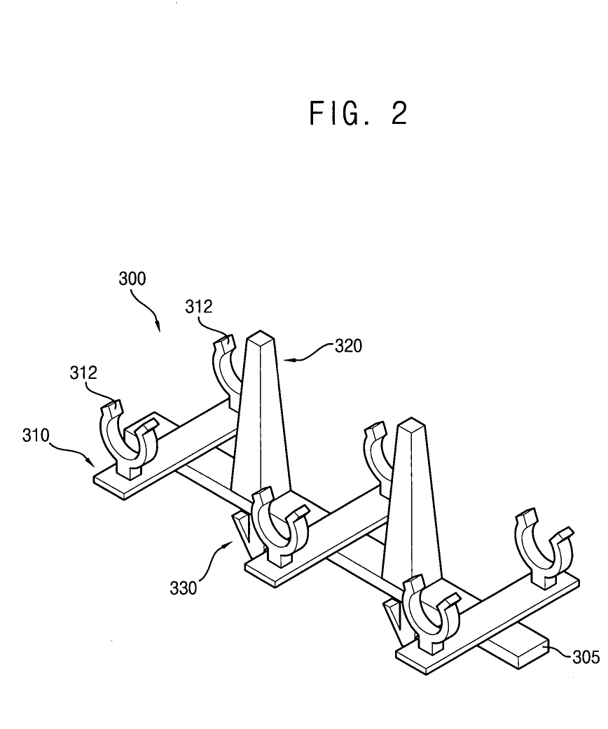

The lamp supporter 300 is combined with and disposed above the bottom plate 210 to support the lamps 400 within the receiving container 200. In an exemplary embodiment, the backlight assembly 100 includes a plurality of lamp supporters 300. Referring to FIG. 2, the lamp supporter 300 includes a base part 305, a plurality of lamp supporting parts 310 connected to the base part 305, and two spaced apart lamp holders 312 disposed on each lamp supporting part 310. Each of the lamp supporting parts 310 corresponds to at least one lamp 400. In an alternative exemplary embodiment, each of the lamp supporting parts 310 may have one or more than two spaced apart lamp holders 312. Each of the lamp holders 312 includes an opened portion configured for receiving a portion of a lamp 400, where the lamps 400 are disposed in receiving container 200 and extend along a longitudinal direction that is illustrated substantially parallel to sidewall 220. In another alternative embodiment, each of the lamp holders 312 may be configured for receiving a portion of a lamp 400, where the lamps 400 are disposed in receiving container 200 and extend along a horizontal direction that is substantially perpendicular to sidewall 220. In another alternative exemplary embodiment, at least two lamp supporters 300 may be spaced apart from each other along the length of lamps 400 in a manner to provide multiple points of support for the same lamp 400. Energy from an impact applied to an external portion of backlight assembly 100 is thereby dissipated among a plurality of lamp supporters 300 and lamp holders 312, rather than a single lamp supporter 300.

The lamps 400 may be disposed on the bottom plate 210 of the receiving container 200 substantially parallel with one another. The lamps 400 generate light based on an electric power source (not shown) provided to the backlight assembly 400. In an exemplary embodiment, each of the lamps 400 may be a cold cathode fluorescent lamp (CCFL) that has an extended cylindrical shape. Referring again to FIG. 1, backlight assembly 100 may further include a plurality of lamp fixing members 410 configured to receive and support end portions of lamps 400. The lamp fixing members 410 are secured to the receiving container 200. When a length of each of the lamps 400 is increased, the lamp supporter 300 may be utilized to support a portion of the lamp 400 between end portions of the lamp 400. In alternative exemplary embodiments, lamp supporter 300 and lamp fixing member 410 may be configured for receiving lamps 400 having a U shape, or where each of the lamps 400 may be an external electrode fluorescent lamp (EEFL) that has external electrodes on end portions of the EEFL.

The backlight assembly 100 may further include a diffusion plate 500 disposed above the lamps 400 to diffuse the light generated from the lamps 400 with a substantially uniform luminance. The diffusion plate 500 may have a substantially plate shape including a predetermined thickness. The diffusion plate 500 is spaced apart from the lamps 400. The diffusion plate 500 may include a transparent material and a diffusing agent. In an exemplary embodiment, the diffusion plate 500 comprises polymethyl methacrylate (PMMA).

The backlight assembly 100 may further include at least one optical sheet 510 disposed above the diffusion plate 500. The optical sheet 510 guides the light that has passed through the diffusion plate 500, and improves optical characteristics of the light. The optical sheet 510 may include a bright enhancement film (BEF) for increasing the luminance of the light having passed through the diffusion plate 500. The optical sheet 510 may further include a diffusion sheet (not shown) that diffuses the light that has passed through the diffusion plate 500 in a manner that provides light with a substantially uniform luminance. Alternatively, the optical sheet 510 may further include various optical films.

Alternative exemplary embodiments of the backlight assembly 100 may further include a side mold 520 configured to receive end portions of the lamps 400. The side mold 520 may cover the end portions of the lamps 400. Additionally, the side mold 520 may be combined with the receiving container 200. Alternative exemplary embodiments of the side mold 520 may support and/or guide the diffusion plate 500.

Alternative embodiments of the backlight assembly 100 may further include a middle mold (not shown) to secure the diffusion plate 500 and the optical sheet 510. Alternatively, the middle mold may be combined with the receiving container 200 to secure the optical sheet 510 and or the diffusion plate 500.

FIG. 2 is a perspective view showing an exemplary embodiment of a lamp supporter shown in FIG. 1.

Referring to FIG. 2, the lamp supporter 300 includes a base part 305 and at least one lamp supporting part 310 connected to the base part 305. For example, the lamp supporting part 310 crosses the base part 305. In an exemplary embodiment, the lamp supporter 300 includes three lamp supporting parts 310 spaced apart from one another by substantially a similar distance. In alternative exemplary embodiments, the lamp supporters 300 may not be spaced apart from each other a similar distance and may include any of a number of supporting parts 310 suitable for the purpose described herein.

In an exemplary embodiment, each of the lamp supporting parts 310 has two lamp holders 312 spaced apart from each other by a predetermined distance. For example, the lamp holders 312 are spaced apart from each other by about 20 mm to about 30 mm. The lamp holders 312 are configured to receive a portion of a lamp 400, for example being configured as an opened portion in a longitudinal direction of the lamps 400 having a shape substantially similar to a portion of the lamp 400, thereby providing support for the lamp 400. When each of the lamps 400 is inserted into the opened portion of the lamp holders 312 of the lamp supporting part 310, each of the lamps 400 is essentially fixed to the bottom plate 210 through the lamp supporter 310. That is, each of the lamps 400 is securely combined with the lamp supporter 310 so that the lamp 400 may not be separated from the lamp supporter 310. The externally provided impact is dissipated into the lamp holders 312 so that the amount of the impact that is applied on each of the lamp holders 312 is decreased. Advantageously, a plurality of lamp holders 312 supporting the lamp 400 rather than a single lamp holder 312 better distributes an impact applied to an external portion of the backlight assembly 100.

A width of the opened portion of the lamp holder 312 may be determined by a diameter of each of the lamps 400. When the width of the opened portion of the lamp holder 312 is increased, the lamp 400 may be easily inserted into the lamp holder 312. However, when the width of the opened portion of the lamp holder 312 is too large, the lamp may be easily separated from the lamp supporter 300. In an exemplary embodiment, a ratio of the width of the opened portion of the lamp holder 312 to the diameter of the lamp 400 may be about 80% to about 90%. For example, when the diameter of the lamp 400 is about 4 mm, the width of the opened portion of the lamp holder 312 is about 3.3 mm.

In an exemplary embodiment, the lamp supporter 300 further include at least one diffusion plate supporting part 320 configured to support the diffusion plate 500. The diffusion plate supporting part 320 protrudes from the base part 305 higher than the lamp holder 312. The diffusion plate supporting part 320 supports an inner portion of the diffusion plate 500 to substantially reduce or prevent sagging of the diffusion plate 500, thereby maintaining a space between the lamps 400 and the diffusion plate 500 when the lamp supporter 300 is installed in the backlight assembly 100. In an exemplary embodiment, the diffusion plate supporting part 320 is disposed on base part 305 between the lamp supporting parts 310. In this exemplary embodiment, two diffusion plate supporting parts 310 are between three lamp supporting parts 310. Alternatively, the number and spacing of the diffusion plate supporting parts 320 and the lamp supporting parts 310 may vary from that illustrated in FIG. 2. Further, alternative embodiments include diffusion plate supporting parts 320 disposed on lamp supporting part 310 between lamp holders 312.

In an exemplary embodiment, the lamp supporter 300 further includes at least one securing portion 330. The securing portion 330 extends from base part 305 in a direction opposite the diffusion plate supporting parts 320. In an exemplary embodiment, two securing portions 330 are formed under the diffusion plate supporting parts 320 and extend from base part 305. The number and the location of the securing portions 330 may vary in alternative embodiments. In an exemplary embodiment, the securing portion 330 engages the bottom plate 210 of the receiving container 200 in a manner to secure the lamp supporter 300 to the receiving container 200. For example, the securing portion 330 may be configured to include a hook portion that engages the bottom plate 210 of the receiving container 200. Portions of the lamp supporter 300, for example the securing portion 330, may also be configured to maintain a predetermined space between the lamp supporting part 310 and the bottom plate 210.

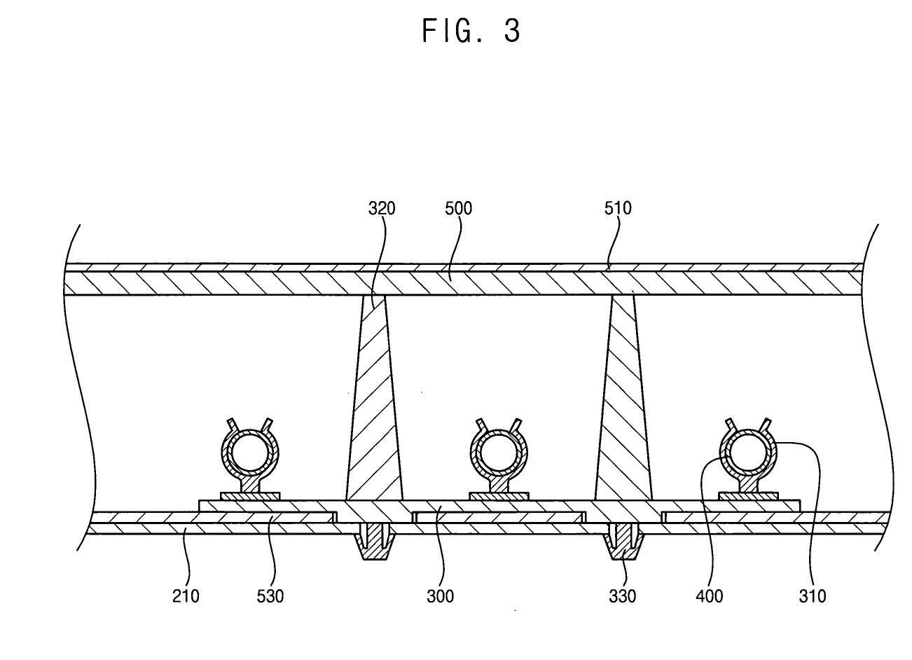

FIG. 3 is a cross-sectional view showing the backlight assembly shown in FIG. 1.

Referring to FIG. 3, an exemplary embodiment illustrates the lamp supporter 300 supporting and fixes the lamps 400. In addition, the lamp supporter 300 engages the bottom plate 210 of the receiving container 200, while diffusion plate supporting parts 320 are configured to support the diffusion plate 500. Further, the diffusion plate supporting part 320 and the securing portion 330 may also be configured to maintain a predetermined space between the lamp supporting part 310 and the bottom plate 210.

The lamps 400 are combined with the lamp supporting parts 310 through the lamp holders 312. The lamps 400 are substantially parallel with one another on the bottom plate 210. In an exemplary embodiment, the diffusion plate supporting parts 320 are configured to support the diffusion plate 500 in a manner that maintains a predetermined space between the lamps 400 and the diffusion plate 500.The diffusion plate 500 is on the lamps 400, and the optical sheet 510 is on the diffusion plate 500. The diffusion plate 500 is supported by the diffusion plate supporting parts 320 to be spaced apart from the lamps 400 by a constant distance. In another exemplary embodiment, the backlight assembly 100 further includes a reflecting plate 530 for reflecting light from lamps 400 in a direction toward diffusion plate 500. The reflecting plate 530 is disposed between the bottom plate 210 and the lamps 400. The light generated from the lamps 400 is reflected from the reflecting plate 530 so that the luminance of the backlight assembly 100 is increased. In an exemplary embodiment, the reflecting plate 530 is attached to the bottom plate 210 or the receiving container 200.

In an exemplary embodiment, portions of the reflecting plate 530 and the bottom plate 210 of the receiving container 200 include apertures or openings configured for receiving the securing portions 330 of the lamp supporter 300. For example, the securing portion 330 may be configured such that when inserted into the apertures of the reflecting plate 530 and the bottom plate 210, the diffusion plate supporting part 320 maintains a predetermined distance between the diffusion plate 500 and the bottom plate 210.

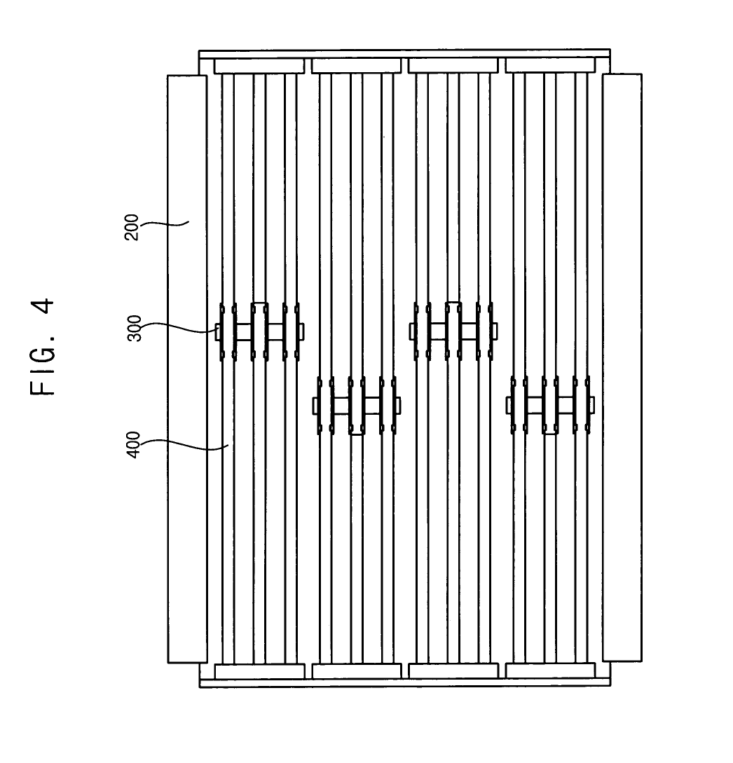

FIG. 4 is a plan view showing an exemplary embodiment of a receiving container, lamp supporters and lamps shown in FIG. 1.

Referring to FIG. 4, in an exemplary embodiment, the lamp supporters 300 are arranged in a zigzag shape along the longitudinal direction of the lamps 400 so a lamp supporter 300 is offset with respect to an adjacent lamp supporter 300. In an alternative embodiment, the lamp supporters 300 may be offset with respect to each other in a similar manner for lamps disposed in receiving container 200 along a horizontal direction of the lamps 400. When the lamp supporters 300 are arranged to be substantially in line with one another, the lamp supporters 300 may partially block the light generated from the lamps 400 so that a dark line may appear in the backlight assembly 100. In an exemplary embodiment, the lamp supporters 300 are arranged offset with respect to each other in a manner that substantially reduces or prevents the formation of the dark line.

In an exemplary embodiment, each of the lamps 400 is supported by at least one of the lamp supporters 300. Alternatively, when a length of the lamps 400 is increased, the number of the lamp supporters 300 used to support the lamps 400 may be increased. Specifically, alternative embodiments include a plurality of lamp supporters 300 spaced along the length of a long lamp 400 for supporting the lamp 400. Although the number of the lamp supporters 300 supporting a set of lamps 400 may be increased, the lamp supporters 300 may be still be arranged in the receiving container 200 so one lamp supporter 300 is offset with respect to an adjacent lamp supporter 300 that supports another set of lamps 400. In an alternative embodiment, the lamp supporters 300 may be disposed within the receiving container 200 in a zigzag arrangement when the backlight assembly is viewed from a direction above the lamps 400.

Exemplary embodiments of a lamp supporter include configurations made from metal or plastic. Further, the lamp supporter may comprise a transparent material such as polycarbonate (PC), polyethyleneterephthalate (PET), etc.

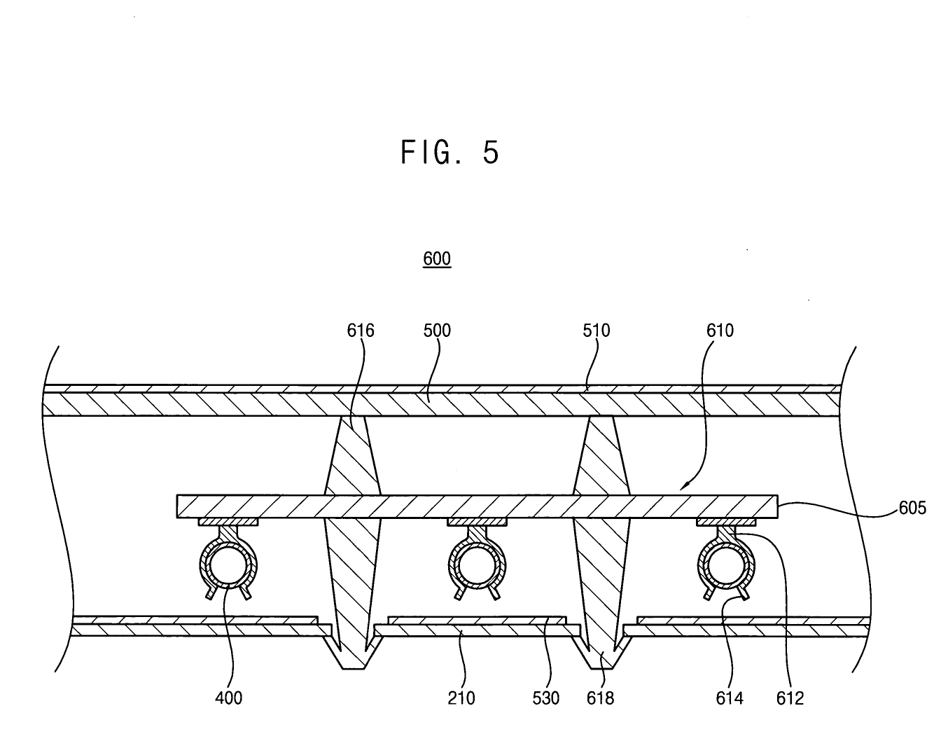

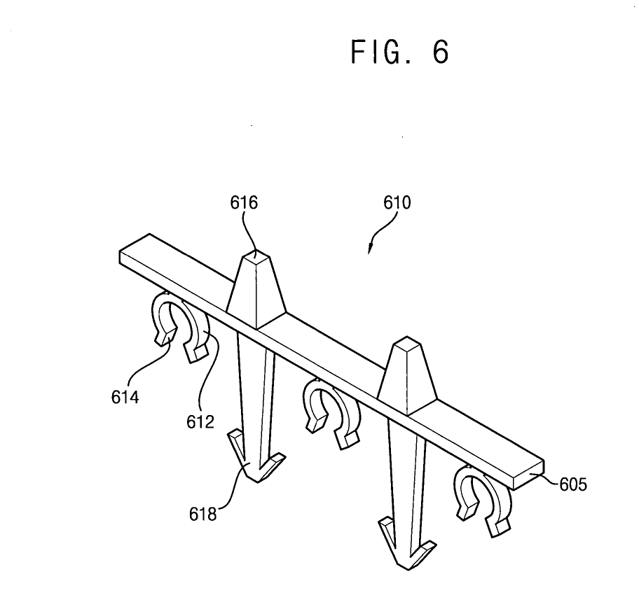

FIG. 5 is a cross-sectional view showing another exemplary embodiment of a backlight assembly in accordance with the present invention. FIG. 6 is a perspective view showing an exemplary embodiment of a lamp supporter shown in FIG. 5. The backlight assembly of FIG. 5 is substantially similar as the backlight assembly 100 in FIGS. 1, 3 and 4 except for a configuration of a lamp supporter. Thus, the same reference numerals will be used to refer to the same or like parts as those described in FIGS. 1 to 4 and any further explanation will be omitted.

Referring to FIGS. 5 and 6, the backlight assembly 600 includes a plurality of lamp supporters 610 that support lamps 400 and a diffusion plate 500.

In an exemplary embodiment, each of the lamp supporters 610 includes a base part 605 and at least one lamp supporting part 612 connected to the base part 605. For example, the lamp supporting part 612 crosses the base part 605. In an exemplary embodiment, each of the lamp supporters 610 includes three lamp supporting parts 612. A distance between adjacent lamp supporting parts 612 may be substantially similar to a distance between adjacent lamps 400. In an alternative embodiment, each of the lamp supporters 610 may have two or more lamp supporting parts 612.

Each of the lamp supporting parts 612 has a lamp holder 614 configured for receiving a lamp 400. In an exemplary embodiment, each of the lamp holders 614 includes an opened portion facing toward the bottom plate 210 of the receiving container 200. The lamp supporting parts 612 are spaced apart from the bottom plate 210 so that the lamp holders 614 are spaced apart from the bottom plate 210 when the lamp supporter 600 is installed in the backlight assembly 600. The lamps 400 are inserted into the lamp holders 614 to be combined with the lamp supporting parts 612. Further, each of the lamp holders 614 is opened toward the bottom plate 210 to protect the lamps 400 from a vertical impact applied to an exterior portion of the backlight assembly 600. In addition, the lamp holders 614 may be configured so that the lamps 400 may not substantially be separated from the lamp supporting parts 612 when the lamps 400 are inserted into the lamp holders 614.

The lamp supporter 610 further includes at least one diffusion plate supporting part 616 configured for supporting the diffusion plate 500. The diffusion plate supporting part 616 extends from base part 605 in a direction opposite the lamp supporting parts 612. The diffusion plate supporting part 616 supports an inner portion of the diffusion plate 500 to prevent a sagging of the diffusion plate 500, thereby maintaining a space between the lamps 400 and the diffusion plate 500 when the lamp supporter 610 is installed in the backlight assembly 600. In an exemplary embodiment, each diffusion plate supporting part 616 may be disposed on the base part 305 between the lamp supporting parts 612. For example, the lamp supporter 610 includes two diffusion plate supporting parts 616 and three lamp supporting parts 612 as illustrated in FIG. 5. In alternative exemplary embodiments, the number and spacing of the diffusion plate supporting parts 616 and the lamp supporting parts 612 may be vary from that illustrated in FIG. 5 as suitable for the purpose described herein.

The lamp supporter 610 further includes at least one securing portion 618. The securing portion 618 extends from base part 605 in a direction opposite the diffusion plate supporting parts 616. In an exemplary embodiment, an end portion of the securing portion 618 is configured to engage the bottom plate 210 for securing the lamp supporter 610 to the receiving container 200. Further, the lamp holders 614 are maintained at a space apart from the bottom plate 210 according to the configuration of the securing portion 618. The number and the location of the securing portions 618 may vary in alternative embodiments. The securing portion 618 is combined with the bottom plate 210 of the receiving container 200 to fix the lamp supporter 610 to the receiving container 200. For example, in an exemplary embodiment, the securing portion 618 includes a hook portion configured to engage the bottom plate 210 of the receiving container 200.

In this exemplary embodiment, the lamps 400 are combined with the lamp supporter 610 through the opened portion of the lamp holders 614 that is opened downwardly. The lamp supporter 610 comprises a transparent material such as polycarbonate (PC), polyethyleneterephthalate (PET), etc.

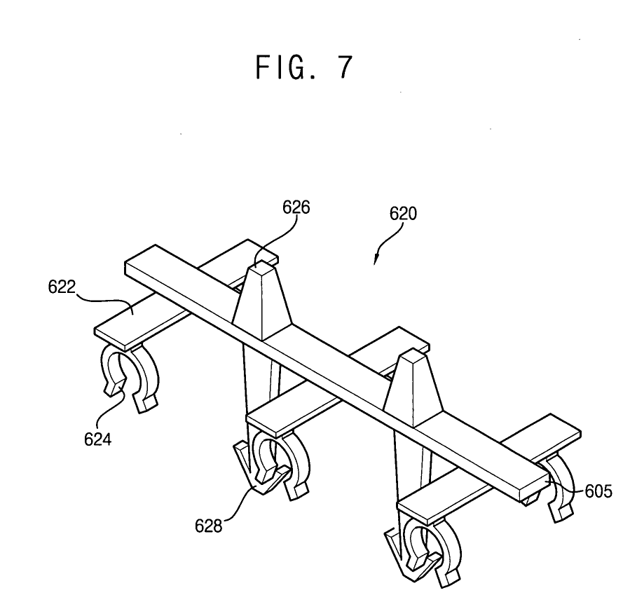

FIG. 7 is a perspective view showing another exemplary embodiment of a lamp supporter in accordance with the present invention.

Referring to FIG. 7, the lamp supporter 620 includes a base part 605 and at least one lamp supporting part 622 connected to the base part 605. The lamp supporting part 622 crosses the base part 605. In an exemplary embodiment, the lamp supporter 620 includes three lamp supporting parts 622 spaced apart from each other a substantially similar distance. Alternative embodiments of lamp supporter 620 include configurations where the lamp supporting parts 622 may be spaced apart from one another by varying distances. Alternatively, the lamp supporter 620 may have two or more lamp supporting parts 622.

Each of the lamp supporting parts 622 has two lamp holders 624 configured to receive a portion of a lamp 400 in a longitudinal direction of the lamps 400. Each of the lamp holders 624 includes an opened portion facing toward the bottom plate 210 of the receiving container 200 when the lamp supporter 620 is installed in the backlight assembly 600. The lamp holders 624 may be spaced apart from each other by a predetermined distance along the longitudinal direction of the lamps 400. For example, the lamp holders 624 may be spaced apart from each other by about 20 mm to about 30 mm. When each of the lamps 400 is inserted into the opened portion of the lamp holders 624, each of the lamps 400 is essentially fixed and supported with respect to the bottom plate 210 through the lamp supporter 620. The lamp supporter 620 is configured to substantially reduce or prevent movement of each of the lamps 400 and to protect the lamps 400 from an impact applied to an exterior portion of the backlight assembly 600.

The lamp supporter 620 further includes at least one diffusion plate supporting part 626 configured to support the diffusion plate 500. The diffusion plate supporting part 626 extends from the base part 605 in a direction opposite the lamp holders 624. The diffusion plate supporting part 626 supports a inner portion of the diffusion plate 500 to prevent a sagging of the diffusion plate 500, thereby maintaining a predetermined distance between the diffusion plate 500 and the lamps 400 when the lamp supporter 620 is installed in the backlight assembly 600. In an exemplary embodiment, the diffusion plate supporting parts 626 may be disposed between the lamp supporting parts 622 as illustrated in FIG. 7. Alternatively, the number and spacing of the diffusion plate supporting parts 626 and the lamp supporting parts 622 may vary from that illustrated in FIG. 7 as suitable for the purpose described herein.

The lamp supporter 620 further includes at least one securing portion 628. The securing portion 628 extends from base part 605 in a direction opposite the diffusion plate supporting parts 626. In an exemplary embodiment, an end portion of the securing portion 628 is configured to engage the bottom plate 210 for securing the lamp supporter 620 to the receiving container 200. Further, the lamp holders 624 are spaced apart from the bottom plate 210 according to the configuration of the securing portion 628. For example, in an exemplary embodiment, the securing portion 628 includes a hook portion configured to engage the bottom plate 210 of the receiving container 200. The number and the location of the securing portions 628 may vary from that illustrated in FIG. 7.

In this exemplary embodiment, the lamps 400 are combined with the lamp supporter 620 through the opened portion of the lamp holders 624 that is opened downwardly. The lamp supporter 620 has transparent material such as polycarbonate (PC), polyethyleneterephthalate (PET), etc.

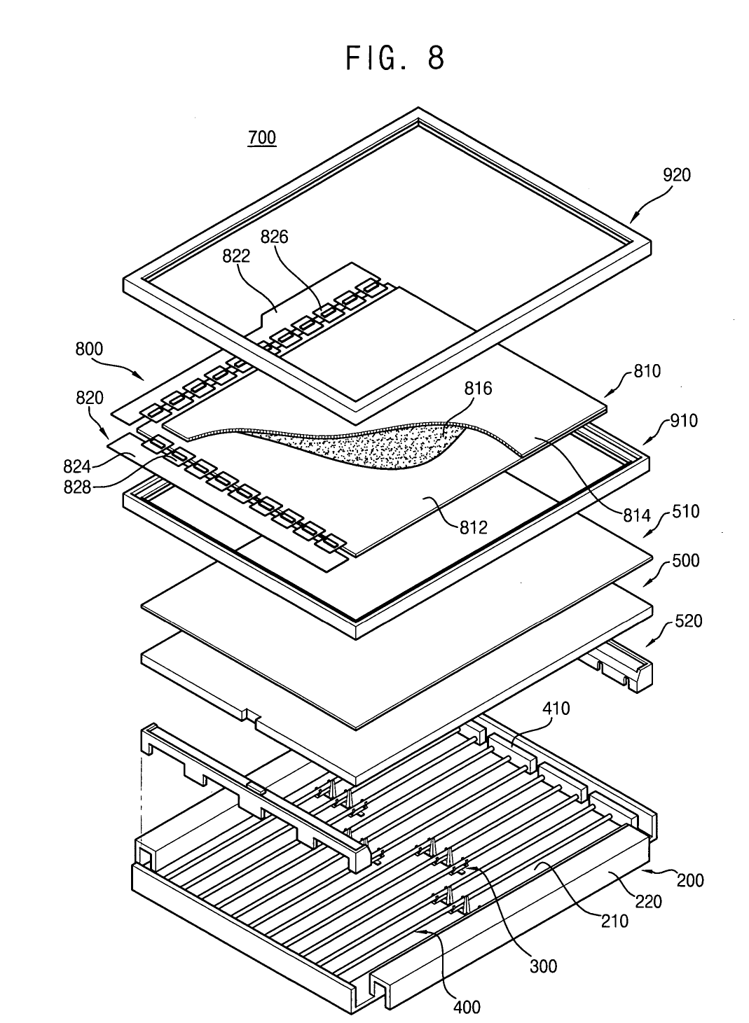

FIG. 8 is an exploded perspective view showing an exemplary embodiment of an LCD device in accordance with the present invention.

Referring to FIG. 8, the LCD device 700 includes a backlight assembly 100 and a display unit 800.

The backlight assembly of FIG. 8 is substantially similar to the backlight assembly in FIGS. 1, and 3-5. Thus, the same reference numerals will be used to refer to the same or like parts as those described in FIGS. 1 to 7 and any further explanation will be omitted.

The display unit 800 includes an LCD panel 810 and a driving circuit part 820. The LCD panel 810 displays images using a light generated from the backlight assembly 100. The driving circuit part 820 applies driving signals to the LCD panel 810.

In an exemplary embodiment, the LCD panel 810 includes a first substrate 812, a second substrate 814 disposed above the first substrate 812, and a liquid crystal layer 816 disposed between the first and second substrates 812 and 814.

The first substrate 812 may include a glass substrate and a plurality of thin film transistors (TFTs) (not shown) arranged in a matrix shape. A source electrode (not shown) of each of the TFTs is electrically connected to one of data lines (not shown) on the glass substrate, and a gate electrode (not shown) of each of the TFTs is electrically connected to one of gate lines (not shown) on the glass substrate. A drain electrode (not shown) of each of the TFTs is electrically connected to a pixel electrode (not shown) on the glass substrate.

The second substrate 814 may include red (R), green (G) and blue (B) color filters (not shown) that are thin films. In addition, the second substrate 814 may further include a common electrode (not shown) disposed on the RGB color filters (not shown). The common electrode (not shown) may be a transparent electrode.

When electric power is applied to the gate electrode on one of the TFTs, an electric field is formed between the pixel electrode (not shown) and the common electrode. An arrangement in the liquid crystal layer 816 varies in response to the electric field applied thereto, and thus a light transmittance thereof may be changed to display the images.

In an exemplary embodiment, the driving circuit member 820 includes a data printed circuit board (PCB) 822, a gate PCB 824, a data flexible circuit film 826, and a gate flexible film 828. The data PCB 822 applies a data driving signal to the LCD panel 810. The gate PCB 824 applies a gate driving signal to the LCD panel 810. The data flexible circuit film 826 electrically connects the data PCB 822 to the LCD panel 810. The gate flexible circuit film 828 electrically connects the gate PCB 824 to the LCD panel 810. Each of the data and gate flexible circuit films 826 and 828 may be a tape carrier package (TCP) or a chip on film (COF).

The data flexible circuit film 826 is backwardly bent or extends in an angular direction with respect to the LCD panel 810 so that the data PCB 822 is disposed on a side surface or a rear surface of the receiving container 200. The gate flexible circuit film 828 extends in an angular direction with respect to the LCD panel 810 or is backwardly bended so that the gate PCB 824 is disposed on the side surface or the rear surface of the receiving container 200. Alternatively, an auxiliary signal line (not shown) may be formed on the LCD panel 810 and the gate flexible circuit film 828 so that the gate PCB 824 may be omitted.

The LCD device 700 further includes a middle mold 910 disposed between the optical sheet 510 and the LCD panel 810. The middle mold 910 secures the optical sheet 510 and the diffusion plate 500, and supports the LCD panel 810. The middle mold 910 may have a substantially frame shape. Alternatively, the middle mold 910 may include a plurality of pieces that are combined with one another to form the middle mold 910. For example, the middle mold 910 may have two U-shaped pieces or four L-shaped pieces.

The LCD device 700 further includes a top chassis 920 that substantially surrounds sides of the LCD panel 810 to be combined with the receiving container 200 to secure the LCD panel 810 with the middle mold 910. The top chassis 920 protects the LCD panel 810 from an impact applied to an exterior portion of the LCD device 700, and substantially reduces or prevents movement of the LCD panel 810 within the LCD device 700. In an exemplary embodiment, the top chassis 920 has a substantially frame shape. Alternatively, the top chassis 920 may include a plurality of pieces that are combined with one another to form the top chassis 920. For example, the top chassis 920 may have two U-shaped pieces or four L-shaped pieces.

According to the present invention, the lamp supporter includes a plurality of the lamp holders configured support the lamps in a manner that dissipates the energy among the lamp holders from an impact applied to an external portion of the LCD device, thereby protecting the lamps from the impact better than a single lamp holder.

In addition, the lamp holders may be configured to include an opened portion facing toward the bottom plate of the backlight assembly so that the lamps are substantially retained in the lamp holders when an impact force is applied to a portion of the backlight assembly from above the lamps.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A lamp supporter comprising:
a base part; and
a lamp supporting part connected to the base part, the lamp supporting part including at least two lamp holders arranged in a first direction, each lamp holder being configured to receive a portion of a lamp.

2. The lamp supporter of claim 1, further comprising a diffusion plate supporting part that supports a diffusion plate.

3. The lamp supporter of claim 2, further comprising a plurality of lamp supporting parts, and the diffusion plate supporting part is disposed between the lamp supporting parts.

4. The lamp supporter of claim 1, further comprising a securing portion, the securing portion configured for securing the lamp supporter with a receiving container.

5. The lamp supporter of claim 4, wherein the securing portion includes a hook portion.

6. A backlight assembly comprising:
a receiving container including a bottom plate and sidewalls that protrude from sides of the bottom plate to form a receiving space;
a lamp supporter combined with the bottom plate, the lamp supporter including a lamp supporting part including at least two lamp holders that are arranged in a first direction; and
a plurality of lamps disposed in the receiving container in the first direction, wherein portions of the lamps are supported by the lamp holders.

7. The backlight assembly of claim 6, wherein the first direction is a longitudinal direction of the lamps or a horizontal direction of the lamps with respect to the lamps disposed in the receiving container.

8. The backlight assembly of claim 6, further comprising a diffusion plate disposed above the lamps to diffuse light generated from the lamps.

9. The backlight assembly of claim 8, wherein the lamp supporter further comprises a diffusion plate supporting part that supports the diffusion plate.

10. The backlight assembly of claim 9, wherein the lamp supporter further comprises a plurality of lamp supporting parts, and the diffusion plate supporting part is disposed between the lamp supporting parts.

11. The backlight assembly of claim 6, wherein the lamp supporter further comprises a securing portion, the securing portion configured for securing the lamp supporter with the bottom plate.

12. The backlight assembly of claim 11, wherein the securing portion includes a hook portion.

13. The backlight assembly of claim 6, further comprising a plurality of lamp supporters arranged so that a first lamp supporter is offset with respect to a second lamp supporter adjacent to the first lamp supporter and with respect to the first direction of the plurality of lamps disposed in the receiving container.

14. The backlight assembly of claim 6, further comprising a reflecting plate disposed between the lamps and the receiving container.

15. A backlight assembly comprising:
a receiving container including a bottom plate and sidewalls that protrude from sides of the bottom plate to form a receiving space;
a lamp supporter combined with the bottom plate, the lamp supporter including a lamp supporting part having a lamp holder that includes an opened portion facing toward the bottom plate; and
a plurality of lamps disposed in the receiving container, wherein a portion of a lamp is supported by the lamp holder.

16. The backlight assembly of claim 15, wherein the lamp holder is spaced apart from the bottom plate by a predetermined distance.

17. The backlight assembly of claim 15, wherein the lamp supporting part further comprises at least two lamp holders that are arranged in a first direction of the lamps and spaced apart from each other by a predetermined distance.

18. The backlight assembly of claim 15, further comprising a diffusion plate disposed above the lamps, the diffusion plate configured to diffuse light generated from the lamps, and the lamp supporter further comprises a diffusion plate supporting part that supports the diffusion plate.

19. The backlight assembly of claim 15, further comprising a reflecting plate disposed between the lamps and the receiving container and the lamp supporter further comprising a securing portion combined with the receiving container, wherein the reflecting plate includes openings configured to receive the securing portion.

20. The backlight assembly of claim 15, wherein the lamp supporter further comprises a securing portion combined with the bottom plate, and the lamp supporting part is spaced apart from the bottom plate by a predetermined distance using the securing portion.

21. The backlight assembly of claim 15, wherein the lamp supporter comprises a transparent material.

22. The backlight assembly of claim 15, further comprising a plurality of lamp supporters arranged in a zigzag shape with respect to a first direction of the lamp.

23. A liquid crystal display device comprising:
a backlight assembly including:
a receiving container including a bottom plate and sidewalls that protrude from sides of the bottom plate to form a receiving space;
a lamp supporter combined with the bottom plate, the lamp supporter including a lamp supporting part having at least two lamp holders that are arranged in a first direction; and
a plurality of lamps disposed in the receiving container, wherein portions of the lamps are supported by the lamp holders; and
a liquid crystal display panel that displays images using a light generated from the backlight assembly.

24. The liquid crystal display device of claim 23, wherein the backlight assembly further comprises a diffusion plate disposed above the lamps, and the lamp supporter further comprises a diffusion plate supporting part that supports the diffusion plate.

25. The liquid crystal display device of claim 23, wherein the lamp supporter further comprises a securing portion configured for securing the lamp supporter with the bottom plate.

26. A liquid crystal display device comprising:
a backlight assembly including:
a receiving container including a bottom plate and sidewalls that protrude from sides of the bottom plate to form a receiving space;
a lamp supporter combined with the bottom plate, the lamp supporter including a lamp supporting part having a lamp holder that includes an opened portion facing toward the bottom plate; and
a plurality of lamps disposed in the receiving container, wherein a portion of a lamp is supported by the lamp holder; and
a liquid crystal display panel that displays an image using light generated from the backlight assembly.

27. The liquid crystal display device of claim 26, wherein the lamp supporting part further comprises at least two lamp holders that are arranged in a first direction of the lamps and spaced apart from each other by a predetermined distance.

28. The liquid crystal display device of claim 26, wherein the backlight assembly further comprises a diffusion plate disposed above the lamps, and the lamp supporter further comprises a diffusion plate supporting part that supports the diffusion plate.

29. The liquid crystal display device of claim 26, wherein the lamp supporter further comprises a securing portion configured for securing the lamp supporter with the bottom plate, and the lamp supporting part is spaced apart from the bottom plate by a predetermined distance using the securing portion.
